(19) United States
(12) Patent Application Publication
(10) Pub. No.: US 2011/0258045 A1
(43) Pub. Date: Oct. 20, 2011

(54) INVENTORY MANAGEMENT

(75) Inventors: David M. Chickering, Bellevue, WA (US); Christopher A. Meek, Kirkland, WA (US); Denis X. Charles, Bellevue, WA (US); Robert Elliott Tillman, Pittsburgh, PA (US)

(73) Assignee: MICROSOFT CORPORATION, Redmond, WA (US)

(21) Appl. No.: 12/761,961

(22) Filed: Apr. 16, 2010

(51) Int. Cl. G06Q 30/00; G06N 5/02; G06F 15/18; G06Q 10/00

(52) U.S. Cl. 705/14.53; 705/14.4; 705/14.73; 706/12; 706/52

(57) ABSTRACT

Various embodiments provide techniques for inventory management. In one or more embodiments, a probabilistic model is constructed to represent an inventory of ad impressions available from a service provider. The probabilistic model can be based on a traffic model that describes historic interaction of clients with the service provider using various attributes that define the ad impressions. The probabilistic model provides a distribution of the attributes and relates the attributes one to another based on dependencies. When an order from an advertiser for ad impressions is booked by the service provider, the probabilistic model is updated to reflect an expected probabilistic decrease in the inventory of ad impressions. The updated probabilistic model can then be employed to determine whether the inventory of ad impressions is sufficient to book subsequent orders for ad impressions.

### BACKGROUND

In display advertising for online resources, advertisers make orders targeted to specific customers which are matched to inventory which represents attributes of the customers (e.g., impressions) defined by the orders. Allocation of the orders to the inventory is a complex constraint satisfaction problem, which can be computationally expensive to solve precisely for large numbers of available inventories (e.g., billions every day) and/or large numbers of advertiser orders (tens of thousands) that can be associated with a service provider. In this context, the service provider can be concerned with inventory management to enable booking of a maximum number of orders and ensure that the booked orders are fulfilled.

When orders are booked, the inventory-management system can estimate available inventory that results by subtracting out impressions consumed by the orders. To obtain an accurate estimate of available inventory, the subtraction accounts for a number of orders that overlap (e.g., orders that target common attributes). One traditional technique for performing the subtraction involves calculating a number of impressions originally available for a prospective order (e.g., how many impressions having attributes designated by the order are available in an initial inventory). Then, for each overlapping order, an amount of impressions consumed by the order is subtracted from the original number of impressions that is counted. The expected remaining impressions that are obtained as a result of this subtraction can be used to determine impressions that are available for subsequent orders.

This traditional approach, though, results in a new distribution over the attributes associated with impressions that may no longer be accurately represented by the original probabilistic model. In addition, the traditional approach can be too slow and computationally expensive for high volumes of real-time availability computations that occur in some scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide techniques for inventory management. In one or more embodiments, a probabilistic model is constructed to represent an inventory of ad impressions available from a service provider. The probabilistic model can be based on a traffic model that describes historic interaction of clients with the service provider using various attributes that define the ad impressions. The probabilistic model provides a distribution of the attributes and relates the attributes one to another based on dependencies. When an order from an advertiser for ad impressions is booked by the service provider, the probabilistic model is updated to reflect an expected probabilistic decrease in the inventory of ad impressions. The updated probabilistic model can then be employed to determine whether the inventory of ad impressions is sufficient to book subsequent orders for ad impressions.

### BRIEF DESCRIPTION OF THE DRAWINGS

FIG. 1 illustrates an example operating environment in which one or more embodiments of inventory management can be employed.

FIG. 2 is a flow diagram that describes an example procedure in accordance with one or more embodiments.

FIG. 3 is a flow diagram that describes an example procedure in accordance with one or more embodiments.

FIG. 4 is a diagram that depicts an example probabilistic model in accordance with one or more embodiments.

FIG. 5 is a diagram that depicts another example of a probabilistic model in accordance with one or more embodiments.

FIG. 6 illustrates an example Venn diagram that represents overlapping attributes in accordance with one or more embodiments.

FIG. 7 is a block diagram of a system that can implement the various embodiments.

### DETAILED DESCRIPTION

Overview

Various embodiments provide techniques for inventory management. In one or more embodiments, a probabilistic model is constructed to represent an inventory of ad impressions available from a service provider. The probabilistic model can be based on a traffic model that describes historic interaction of clients with the service provider using various attributes that define the ad impressions. The probabilistic model provides a distribution of the attributes and relates the attributes one to another based on dependencies. When an order from an advertiser for ad impressions is booked by the service provider, the probabilistic model is updated to reflect an expected probabilistic decrease in the inventory of ad impressions. The updated probabilistic model can then be employed to determine whether the inventory of ad impressions is sufficient to book subsequent orders for ad impressions.

In the discussion that follows, a section entitled “Operating Environment” describes but one environment in which the various embodiments can be employed. Following this, a section entitled “Inventory Management Procedures” describes example techniques for inventory management in accordance with one or more embodiments. Next, a section entitled “Inventory Management Implementation Details” describes example algorithms and implementations for inventory management in accordance with one or more embodiments. Last, a section entitled “Example System” is provided and describes an example system that can be used to implement one or more embodiments.

Operating Environment

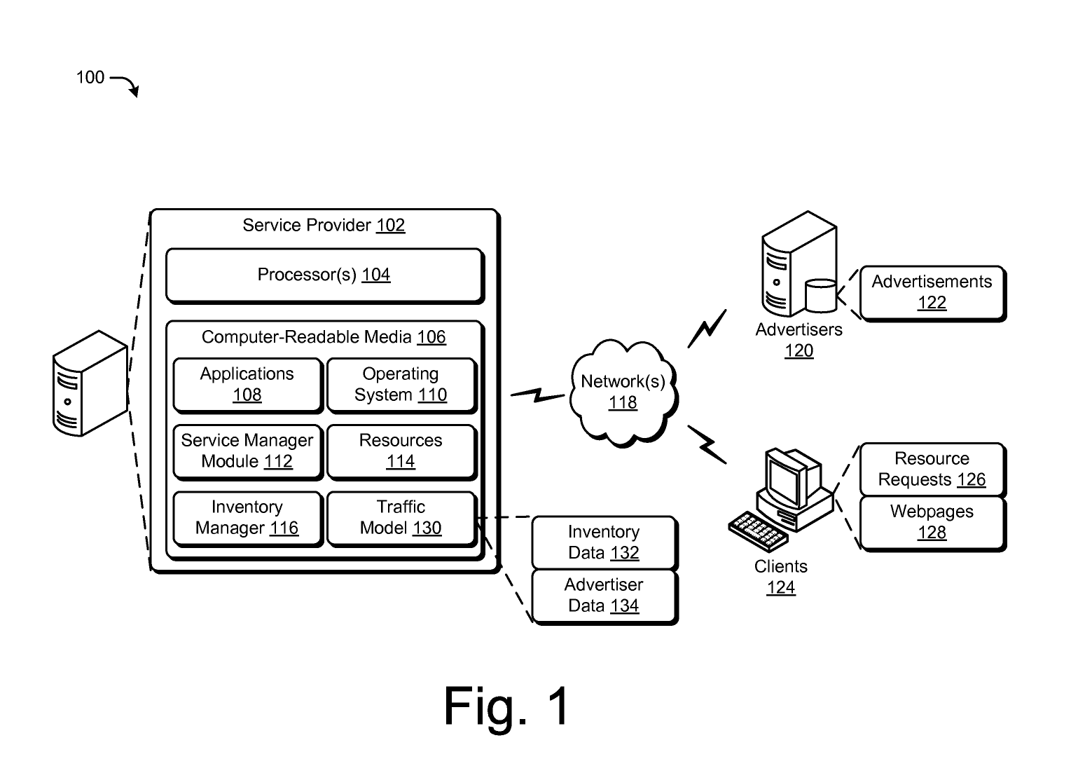

FIG. 1 illustrates an operating environment in accordance with one or more embodiments, generally at 100. Environment 100 includes a service provider 102 having one or more processors 104, one or more computer-readable media 106 and one or more applications 108 that are stored on the computer-readable media and which are executable by the one or more processors 104. The computer-readable media 106 can include, by way of example and not limitation, all forms of volatile and non-volatile memory and/or storage media that are typically associated with a computing device. Such media can include ROM, RAM, flash memory, hard disk, optical disks, removable media, and the like. Computer-readable media 106 is also depicted as storing an operating system 110, a service manager module 112, resources 114 (e.g., content, services, and data), and an inventory manager 116 that may also be executable by the processor(s) 104. While illustrated separately, the inventory manager 116 may also be implemented as a component of the service manager module 112.

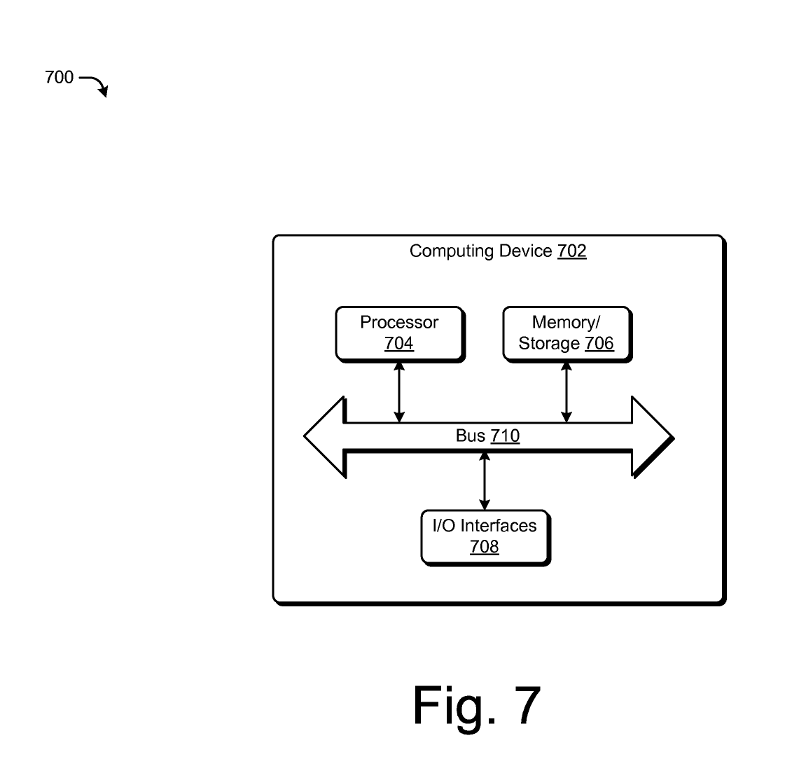

Service provider 102 can be embodied as any suitable computing device or combination of devices such as, by way of example and not limitation, a server, a server farm, a peer-to-peer network of devices, a desktop computer, and the like. One specific example of a computing device is shown and described below in relation to FIG. 7. Service provider 102 can be communicatively coupled over a network 118 to various other entities (e.g., devices, servers, storage locations, clients, and so forth). In particular, service provider 102 is illustrated as being connected over the network 118 to advertisers 120 that provide advertisements 122 and clients 124. Advertisers 120 and clients 124 may interact over the network 118 with the service provider 102 to obtain access to various resources 114. Although the network 118 is illustrated as the Internet, the network may assume a wide variety of configurations. For example, the network 118 may include a wide area network (WAN), a local area network (LAN), a wireless network, a public telephone network, an intranet, and so on. Further, although a single network 118 is shown, the network 118 may be configured to include multiple networks.

Service manager module 112 represents functionality operable by service provider 102 to manage various resources 114 that may be made available over the network 118. Service manager module 112 may manage access to the resources 114, performance of the resources 114, configuration of user interfaces or data to provide the resources 114, and so on. For example, clients 124 may form resource requests 126 for communication to the service provider 102 to obtain corresponding resources 114. In response to receiving such requests, service provider 102 can provide various resources 114 via webpages 128 and/or other user interfaces that are communicated over the network 118 for output by the one or more clients 124.

Resources 114 can include any suitable combination of content and/or services typically made available over a network by one or more service providers. Content can include various combinations of text, video, ads, audio, multi-media streams, animations, images, content for display by a browser or other client application, and the like. Some examples of services include, but are not limited to, a search service, an email service to send and receive email, an instant messaging service to provide instant messages between clients, and a social networking service to facilitate connections and interactions between groups of users who share common interests and activities. Services may also include an advertising service configured to enable advertisers 120 to place advertisements 122 for presentation to clients 104 in conjunction with the resources 114.

Advertisements 122 can be delivered to clients 104 along with a variety of resources 114 including, but not limited to, webpages and/or other pages or documents associated with applications 108, user interfaces of applications 108, emails or other electronic messages, and so forth. For instance, at least some of the webpages 128 output by a browser can be configured to include advertisements 122 provided by the advertisers 120. Pages associated with other applications 108 of a client 104 can also be configured with one or more portions to display advertisements. Additionally, a user interface for a browser or other application 108 can also include one or more portions of the user interface itself that may be configured to present advertisements 122. Advertisements 122 can also be delivered within electronic messages by way of email or other forms of electronic messaging to user inboxes.

Advertisements 122 may be selected for inclusion with various resources 114 through an advertisement service using any suitable techniques for selection and delivery of the ads. In one example, auctions may be conducted for space that is reserved in a webpage 128 for advertisements 122 from the advertisers 120. Further, booking of orders for ads and delivery of the ads may occur in accordance with inventory management techniques described herein.

The inventory manager 116 is configured to implement aspects of inventory management techniques described herein. The techniques can be employed in the context of managing inventory that relates to impressions used to deliver advertising space reserved in webpages 128, or other resources 114, to advertisers 120. The inventory manager 116 may be configured to make use of a traffic model 130 that represents various data related to interaction of the service provider 102 with clients 124 and/or advertisers 120, and that may be collected, stored, and/or accessed via the service provider 102. Although the example traffic model 130 of FIG. 1 is illustrated as being stored on computer-readable media 106 of the service provider 102, it is contemplated that traffic model 130 may be compiled, stored, and/or obtained by way of any suitable local or network storage location and/or device. In the example of FIG. 1, the traffic model 130 is illustrated as including inventory data 132 and advertiser data 134.

Inventory data 132 can include data related to client interaction with the service provider 102 such as search queries input through a search service, page views, click patterns, demographics, client navigation statistics, client attributes, keyword statistics, and so forth. Inventory data 132 can also include ad impressions that are defined by one or more attributes that relate to clients 124, activities of the clients 124, and/or properties of the clients 124. A client account may also be a source of attributes that relate to demographics, such as locations, genders, and/or ages of a user that initiates the interaction with the service provider 102. In this context, an order may target a set number of impressions that relate to selected attributes, such as one hundred thousand impressions related to “Sports Enthusiast” and “Male.” Advertiser data 134 can include data describing actual and/or simulated orders for impressions from advertisers 120, as well as bids for ad auctions, advertisement delivery schedules, and so forth.

More particularly, the inventory manager 116 represents functionality operable to at least obtain data describing inventory and/or impressions and make use of the data to make assessments regarding whether prospective orders from advertisers 120 can be booked. In at least some embodiments, the inventory manager 116 is configured to construct or otherwise make use of a probabilistic model of available inventory that represents an original distribution over attributes associated with the inventory of ad impressions. Inventory that is available to fulfill orders can be derived using the probabilistic model. When an order is booked, the inventory manager 116 can be configured to update the probabilistic model to reflect an expected new distribution of attributes that results by making probabilistic subtractions of ad impressions from the inventory to account for the booked order. The inventory manager 116 may then make use of the updated probabilistic model to make an availability determination for subsequent orders. Further discussion of inventory management techniques that may be implemented by way of the inventory manager 116 can be found in relation to the following figures.

Having considered an example operating environment, consider now a discussion of example inventory management techniques in accordance with one or more embodiments.

Inventory Management Procedures

The following discussion describes inventory management techniques that may be implemented utilizing the environment, systems, and/or devices described above and below. Aspects of each of the procedures below may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference may be made to the example environment 100 of FIG. 1.

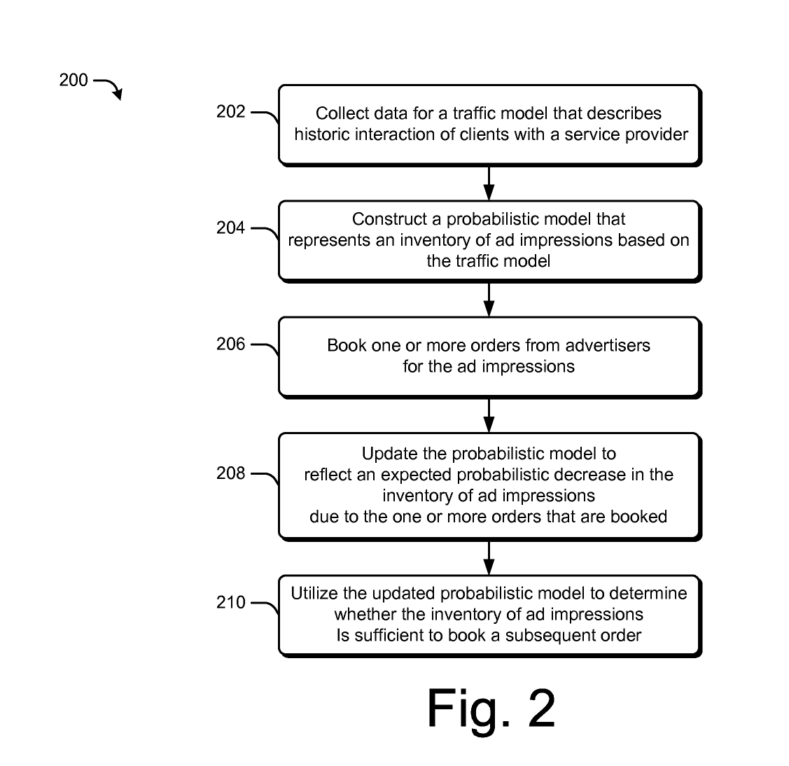

FIG. 2 is a flow diagram that describes an example procedure 200 in accordance with one or more embodiments. In at least some embodiments, the procedure 200 can be performed by a suitably configured computing device, such as a service provider 102 of FIG. 1, or other computing device having an inventory manager 116.

Step 202 collects data for a traffic model that describes historic interaction of clients with a service provider. One way this can occur is by operation of inventory manager 116 to collect inventory data 132 that may be included as part of a traffic model 130 of a service provider 102. Inventory manager 116 can be configured to receive data describing inventory from any suitable source. The inventory data 132 can be compiled periodically such as monthly, quarterly, yearly, and so forth. For instance, data regarding client interactions to navigate webpages, conduct searches, and/or otherwise interact with resources 114 can be compiled for a particular month. The compiled data can then be used as a basis for determining inventory that is available in subsequent months. Each client interaction can be associated with multiple attributes such as gender (male/female), sports fan (yes/no), age 20-40 (yes/no), age category (<21/21-35/36-55/>55), location category (A/B/C/D/E) and so forth. Thus, data describing client interactions can be used to determine various ad impressions having corresponding combinations of attributes that occur for a given period of time (e.g., weekly, monthly, etc.) Accordingly, the service provider 102 can make use of such data to understand an inventory of ad impressions that the service provider 102 has available to sell to advertisers 120.

Step 204 constructs a probabilistic model that represents inventory of ad impressions based on the traffic model. For instance, the inventory manager 116 can make use of the traffic model 130 to construct a probabilistic model of available inventory using historic data. The probabilistic model is configured to relate attributes one to another to account for dependencies between the attributes. Accordingly, probabilities regarding how different attributes overlap can be computed using the model. For instance, the probabilistic model can be used to encode such things as how likely is it that an impression corresponding to a sports fan also corresponds to a male. The probabilistic model that is constructed can be employed to provide an original distribution of attributes for the inventory of ad impressions available from a service provider 102.

A variety of suitable probabilistic models are contemplated. In at least some embodiments, the probabilistic model is configured as a Bayesian network. The Bayesian network can be configured to represent a distribution over various attributes associated with ad impressions. More particularly, the Bayesian network is a directed acyclic graph having edges that connect nodes corresponding to attributes based on probabilistic dependencies between the attributes. Additionally or alternatively, the probabilistic model can be configured as an undirected graph. The undirected graph can be configured to organize dependent attributes into nodes representing cliques (e.g., groups of dependent attributes) and that has edges between cliques that are based upon attributes that are common between adjoining cliques. In at least some embodiments, an undirected graph can be derived from a corresponding Bayesian network. Further details regarding construction and use of various probabilistic models including, but not limited to, Bayesian networks and undirected graphs can be found in the section below entitled “Inventory Management Implementation Details.”

Step 206 books one or more orders for the ad impressions. When one or more orders are booked, Step 208 updates the probabilistic model to reflect an expected decrease in the inventory of ad impressions due to the one or more orders that are booked. For instance, advertisers 120 can place orders for impressions by designating combinations of attributes. For example, orders from advertisers may target attribute combinations such as “Male; 35-45 years of age; interested in sports” or “User who have visited web page x; have not visited page y; have made a purchase of type z in the last n days.” Inventory on which the designated impressions can potentially be delivered have values for each of the attributes associated with the orders. This creates a set of constraints defined by the order. To fulfill an order, the order is matched based on the constraints to inventory and/or impressions that satisfy the constraints.

Each time an order is booked, a number of impressions corresponding to the order can be subtracted from the available inventory of ad impressions. Note that the distribution of attributes may change each time impressions are subtracted from the inventory in response to a booked order. For this reason, continuing to use the original distribution that is computed in step 204 can result in inaccurate results when availability computations are performed for subsequent orders. Accordingly, the inventory manager 116 can be configured to compute an expected probabilistic subtraction from the inventory of ad impressions each time an order is booked. The probabilistic model can be updated to reflect the expected probabilistic subtraction from the inventory and adjust the distribution of attributives prior to considering subsequent orders. By so doing, accuracy of availability computations can be improved.

Step 210 utilizes the updated probabilistic model to determine whether the inventory of ad impressions is sufficient to book a prospective order. For instance, the inventory manager 116 can be configured to make use of the updated probabilistic model to determine whether a prospective new order can be booked. Alternatively, the updated probabilistic model can be used to compute a number of impressions of a given type (e.g., a designated combination of attributes) that can be booked. Further details regarding techniques that can be used to determine whether or not to book prospective orders can be found in relation to the following figure.

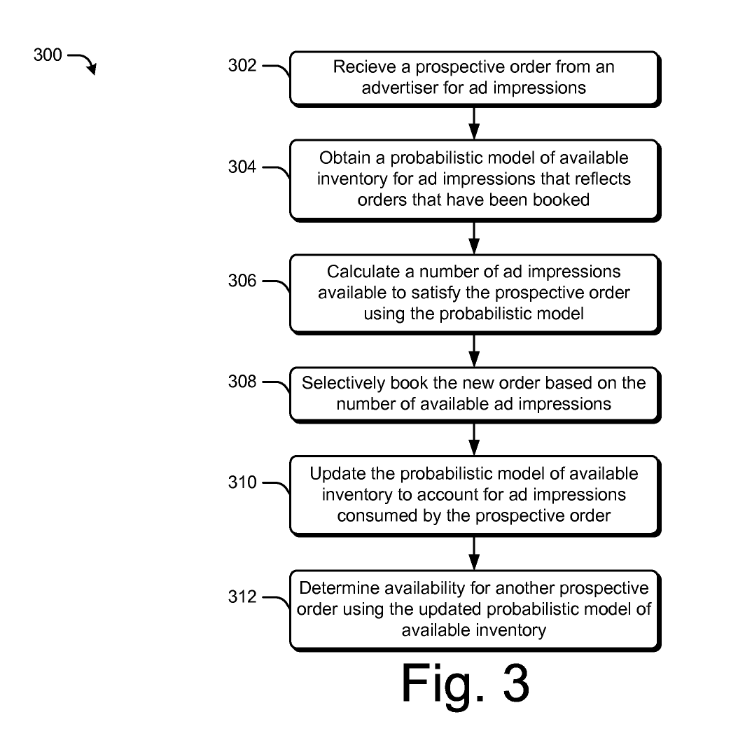

FIG. 3 is a flow diagram that describes another example procedure 300 in accordance with one or more embodiments. In particular, procedure 300 can be employed to make determinations regarding a prospective order for ad impressions. In at least some embodiments, the procedure 300 can be performed by a suitably configured computing device, such as a service provider 102 of FIG. 1, or other computing device having an inventory manager 116.

Step 302 receives a prospective order from an advertiser for ad impressions available from a service provider. The prospective order can be configured to define targeted attributes and a number of impressions requested. Additionally or alternatively, the prospective order can be configured as a query that initiates a determination regarding how many impressions of a particular type are available. For example, a service provider 102 can implement an advertising service that enables advertisers 120 to place orders for impressions that are available from the service provider 102 by designating targeted combinations of attributes. The service provider 102 can have various types of available impressions (e.g., inventory) including but not limited to impressions associated with webpages 128 that can be used to deliver display ads to users that navigate to the webpages 128, search queries input via a search service of the service provider 102, electronic message subscribers who may sign-up to receive advertising messages, application programs and/or associated user interface of clients 124 configured to present ads, and/or other suitable types of impressions that can be employed to deliver ads to clients 124.

Inventory manager 116 can operate to process a prospective order to determine whether or not to book the order (e.g., does sufficient inventory exists) and/or to calculate a number of impressions available that correspond to the prospective order (e.g., how may impressions of the type designated by the order are available). In at least some embodiments, a probabilistic model of available inventory is employed.

In particular, step 304 obtains a probabilistic model of inventory for ad impressions available from the service provider that reflects orders that have been booked by the service provider. As noted, the probabilistic model can be configured to relate attributes associated with impressions one to another to account for relationships between the attributes. For example, consider inventory that has example attributes A, B, C, D, and E. The probabilistic model can be configured to relate these attribute one to another to represent probable combinations of the attributes. In some embodiments, this can involve forming cliques of dependent attributes and thereby identifying groups of attributes that are conditionally independent of one another. For example, one clique may include attributes A, B, and C, and another clique may include attributes C, D, and E. In this example, the model encodes a probability distribution in which the attributes A and B are conditionally independent of D and E given C. Some examples of suitable probabilistic models include a Bayesian network and an undirected graph. Further discussion of suitable probabilistic models can be found in the following section entitled “Inventory Management Implementation Details.”

For a given prospective order, the probabilistic model that is employed can be configured to reflect orders that have already been booked. To do so, an original distribution of attributes for available inventory is obtained and then the distribution can be updated each time an order is booked by the system to account for changes in the population. Each prospective order is then assessed using an updated probabilistic model that accounts for probabilistic subtractions of impressions that occur based on orders that preceded the prospective order. By so doing, inaccuracies that can be associated with continuing to use the original distribution of attributes for successive orders can be avoided.

Given a probabilistic model that reflects an updated distribution of attributes for inventory, step 306 calculates a number of ad impressions available to satisfy the prospective order using the probabilistic model. For example, inventory manager 116 can determine attributes that are designated by the prospective order and compute impressions in the inventory that satisfy these constraints. One way this can occur is by performing a matching operation to match the order with corresponding impressions using the traffic model 130.

Step 308 selectively books the prospective order based upon the calculated number of ad impressions that are available. For example, inventory manager 116 can operate to determine whether a number of available impressions is sufficient to satisfy a number of impressions requested by the prospective order. In at least some embodiments, the inventory manager 116 can be configured to return a binary (yes/no) response regarding whether the order can be booked based upon the calculated number of ad impressions that are available. In another example, inventory manager 116 can be configured to return the calculated number of impressions as a result. For instance, the calculated number of impressions can be returned in response to a query to determine a number of impressions of a particular type that are available. The prospective order can then be booked accordingly. In one example, a prospective order can be booked automatically by the inventory manager 116 according to the determination of available ad impressions. Additionally or alternatively, inventory manager 116 can be configured to output a result of the availability determination in conjunction with an option selectable to proceed with booking the order. The order can then be booked responsive to a selection of the booking option.

When the prospective order is booked, step 310 updates the probabilistic model of available inventory to account for ad impressions consumed by the prospective order. In particular, inventory manager 116 can be configured to make a probabilistic subtraction of impressions from the inventory based upon the order that is booked. To do so, the inventory manager 116 can make use of the probabilistic model and remove impressions from inventory that match the now booked order. The relationships between attributes defined by the probabilistic model enable the inventory manager 116 to determine the different attributes that are associated with the impressions removed from inventory. Accordingly, the inventory manager 116 can compute an updated distribution of the attributes and adjust the probabilistic model accordingly.

Step 312 determines availability for another prospective order using the updated probabilistic model of available inventory. On way this can occur is by operation of the inventory manager 116 to repeatedly update the probabilistic model and make use of the most recent update each time availability for an order is being assessed. For example, the procedure 300 as just described can be used to process multiple prospective orders in turn. In particular, for each prospective order, an updated probabilistic model of available inventory that accounts for previously booked orders can be used to make an inventory availability determination corresponding to the prospective order. When an order is booked, the probabilistic model can be updated again to account for a probabilistic subtraction of impressions from the inventory due to booking of the order. In this manner, the most recent update of the probabilistic model can be employed for each order that is processed.

Having described example procedures involving inventory management, consider now specific implementation examples that can be employed with one or more embodiments described herein.

Inventory Management Implementation Details

Consider now a discussion of example probabilistic models and further implementation details that can be employed using the previously described devices and systems in conjunction with various techniques for inventory management. In the following description, some introductory information regarding Bayesian Networks is first discussed. Thereafter, a discussion describing the construction and use of Bayesian Networks, as well as other probabilistic models, that may be employed for inventory management is presented.

### Bayesian Networks for Inventory Management

As noted previously, a Bayesian network is one example of a suitable probabilistic model that can be employed to implement inventory management techniques described herein. For the benefit of the reader, some brief details regarding Bayesians network in the context of display advertising are now provided.

Assume that a service provider 102 sells user impressions on a website to advertisers 120. For each user impression, there is a value for each of a set of pre-defined attributes. Aᵢ denotes the ith attribute (e.g., gender) and aᵢ denotes a specific value for attribute Aᵢ (e.g., male). With this notation, each impression can be represented as a set of attribute values that are targetable by the advertisers:

A=<a₁, . . . , aₙ>

Advertisers can submit orders to service provider 102 by designating targeted combinations of attributes and a total number of impressions to be provided. For instance, an order Oⱼ={Nⱼ, tⱼ} consists of a total impression count Nⱼ and a set of targeting criteria tⱼ. The targeting criteria of the order specify combinations of attribute values to be satisfied by an impression to show an advertisement corresponding to the order for the impression. For simplicity of presentation, assume for the remainder of this discussion that the criteria for orders are conjunctions of attribute values. For example, an order might be expressed as Oⱼ={1000000, {Gender=Male, SportsFan=Yes}}. In other words, an advertiser 120 would like a million impressions for which the user is both male and a sports fan.

An inventory management system (e.g., inventory manager 116) can be configured to model (a) the number of impressions that are expected for arbitrary targeting criteria and (b) the number of impressions over which two sets of targeting criteria overlap. One technique of doing this is to decompose the problem into two parts as follows:
(1) Model overall traffic volume (e.g., total number of impressions).
(2) Model the joint probability distribution over the attributes A.

By decomposing the problem this way, it is assumed that the probability distribution over the attributes does not depend on the volume. That is, if traffic is doubled it is expected that the number of various combinations of the attribute values also doubles. In practice, a traffic increase can be skewed to one or more attributes, such as by a campaign and/or content that drives more females to a particular site.

A Bayesian network can be used to model the joint probability distribution over a set of attributes A. Bayesian networks can be constructed using historical data, such as data from a traffic model 130. Briefly, a Bayesian network is a graphical model used to represent the joint probability distribution over a set of attributes. The model has two components: (1) a directed acyclic graph (DAC), where there is a node in the graph for each attribute and where edges represent probabilistic dependence between the attributes and (2) a set of parameters that represent the conditional probability of each attribute, given the attributes defined by the corresponding parent nodes in the graph.

As a simple example, assume that the attributes of interest are Gender, SportsFan, and Age, and therefore the probability distribution of interest is P(Gender, SportsFan, Age). There is a node in the model for each attribute, and edges that represent probabilistic dependence between the attributes.

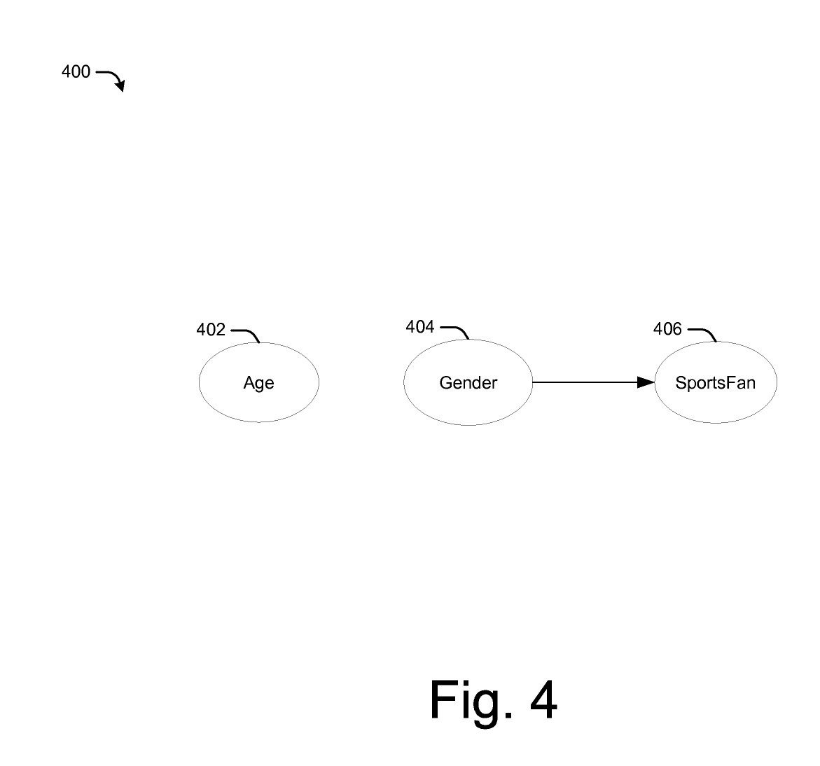

Consider now the example graph 400 that is depicted in FIG. 4. The graph includes an age node 402, a gender node 404, and a SportsFan node 406. The gender node 404 and a SportsFan node 406 are illustrated as being connected by an edge that indicates a probabilistic dependence between these attributes. The lack of an edge between the age mode 402 and either other node asserts the independence between Age and the other attributes. Associated with each node in a Bayesian network is the conditional probability distribution of that attribute given the parent attributes. The joint probability distribution is defined as the product of these conditionals. For the example that is depicted in FIG. 4 this can be expressed as:

p(Gender,SportsFan,Age)=p(Age)p(Gender)p(SportsFan|Gender)

Assuming that the attributes are binary (male/female, yes/no, young/old), the function p(Gender,SportsFan,Age) requires seven total parameters to specify the joint distribution over the attributes. Accordingly, there are eight possible combinations of values and the sum of the probabilities is one. By decomposing p(Gender,SportsFan,Age) into the product of three functions, the number of parameters can be reduced. In particular, p(Age) can be specified with one parameter, p(Gender) can be specified with one parameter, and p(SportsFan|Gender) can be specified with 2 parameters (one parameter for each value of Gender). Accordingly, a total of 4 parameters can be employed. In general, if there are no independencies among attributes, the number of parameters that can be employed to specify the joint distribution over n binary attributes is 2ⁿ. By taking advantage of independence constraints, a Bayesian network can be used to more efficiently represent a distribution of attributes that account for relationships of attributes one to another. Probability distributions of various attribute combinations can then be extracted using the Bayesian network.

### Inference in Bayesian Networks

The process of extracting probabilities over subsets of the attributes is referred to as inference. For example, consider an example of a joint distribution p(Gender, SportsFan, Age), for which the probability p(SportsFan=Yes, Age=Old) is to be determined. The rules of probability dictate that the marginalized probability can be obtained from the joint by summing over the values of all attributes not specified in the query:

$$p ( SportsFan = Yes , Age = Old ) = {\sum }_{g} p ( Gender = g , SportsFan = Yes , Age = Old )$$

Such marginalized probabilities from Bayesian networks can be extracted quite efficiently. In particular, a Bayesian network can be compiled into an undirected graph that is referred to as a junction tree. The junction tree is an undirected graph that can be obtained by modifying the corresponding Bayesian network. The junction tree is configured to have one or more clique node Cᵢ corresponding to groups of dependent attributes. Each clique node Cᵢ in the junction tree (so-called because the nodes correspond to cliques of nodes in a modified version of the Bayesian network) corresponds to a subset of the attributes in the Bayesian network, and the clique node can be employed to store a fully-specified (e.g., no independence constraints) potential function ψ(Cᵢ) that is proportional to the marginal probability distribution p(Cᵢ). A separator set Sᵢⱼ corresponds to an edge between Cᵢ and Cⱼ in the undirected clique graph. The separator set Sᵢⱼ corresponds to the set of attributes Cᵢ∩Cⱼ that are common between two adjoining clique nodes. Each such edge can be stored in conjunction with a potential function ψ(Sᵢⱼ), which is proportional to the marginal probability distribution over the separator set. The joint probability distribution is represented in the junction tree as a ratio of (1) the product of the clique-node potential functions and (2) the product of the separator-set potential functions:

$$p ( {A}_{1} , … , {A}_{n} ) = \frac{1}{Z} \frac{{\prod }_{i} {ψ}_{i} ( {C}_{i} )}{{\prod }_{ij} {ψ}_{ij} ( {S}_{ij} )}$$

In the foregoing expression, Z is a normalizing constant that ensures the probability function sums to one.

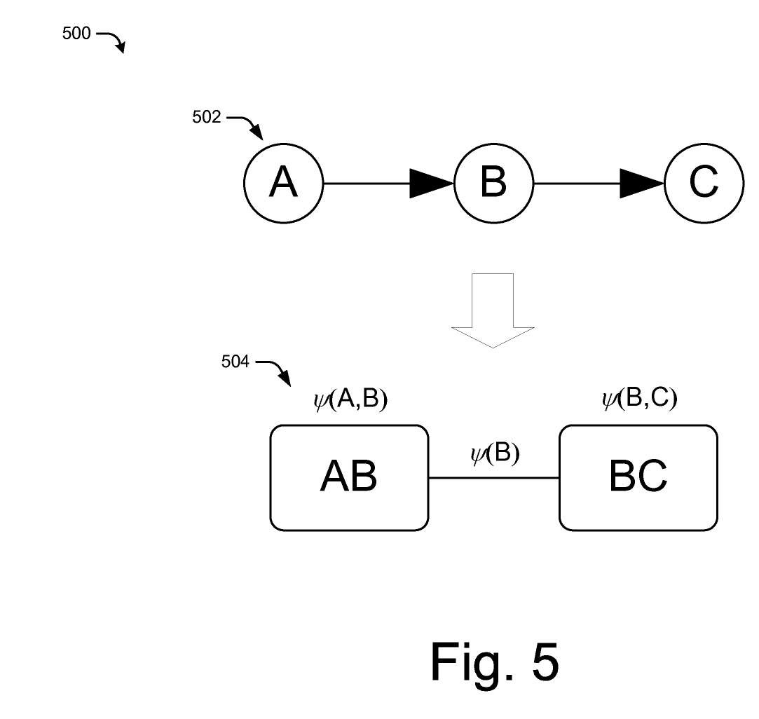

Consider FIG. 5, which depicts generally at 500 an example Bayesian network 502 and a corresponding junction tree 504. In particular, the Bayesian network 502 is defined over example attributes A, B, and C. For the Bayesian network 502, there are two cliques: (A, B) and (B, C). Accordingly, the junction tree 504 can be represented as an undirected graph that includes two nodes as illustrated in the example of FIG. 5.

The joint probability for the example depicted in FIG. 5 is then given by:

$$p ( A , B , C ) = \frac{1}{Z} \frac{{ψ}_{AB} ( {C}_{AB} ) \times {ψ}_{BC} ( {C}_{BC} )}{{ψ}_{B} ( {S}_{B} )}$$

The junction tree 504 has the property that in order to obtain the marginal probability of a given attribute Aⱼ, the following procedure can be employed:
(1) Identify a single clique node Cᵢ that contains attribute Aⱼ (there may be more than one such node).
(2) Sum the potential function over all other attributes in Cᵢ.
(3) “Normalize” the result of (2) such that the values sum to one.

For example, consider a clique node in a junction tree that is defined over attributes A and B, both of which are binary. The corresponding potential function ψ will have a value for the combinations of values for A and B as shown in the following table:

| A | B | ψ(A, B) |
|---|---|---|
| 0 | 0 | 12 |
| 0 | 1 | 10 |
| 1 | 0 | 6 |
| 1 | 1 | 8 |

By summing over the values for B, a new potential function for A can be obtained as follows:

ψ(A=0)=12+10=22

ψ(A=1)=6+8=14

Now, to get the probability of A, ψ can be divided by the sum of the values:

$$p ( A = 0 ) = \frac{ψ ( A = 0 )}{ψ ( A = 0 ) + ψ ( A = 1 )} = \frac{22}{22 + 14} = 0.61$$

$$p ( A = 1 ) = \frac{ψ ( A = 1 )}{ψ ( A = 0 ) + ψ ( A = 1 )} = \frac{14}{22 + 14} = 0.39$$

The junction tree can be updated to reflect new evidence e, so that the resulting set of clique potentials encodes the conditional distribution p(A₁, . . . , Aₙ|e). Inserting evidence into a junction tree works in two phases. First, a single clique is identified for which the corresponding potential function is modified. For example, if evidence A=1 is to be inserted, a single clique containing A is found, and the corresponding potential function is re-set such that all entries corresponding to A≠1 are set to zero.

In a more complicated example, suppose some evidence is obtained that makes A=1 twice as likely as it was before. This evidence can be absorbed into the potential function by multiplying all entries consistent with A=1 (in the example above, the entries for [A=1, B=0] and [A=1, B=1]) by two. In the second phase of inserting evidence, a “propagation” phase can be performed in which messages are passed among the clique nodes in the tree so that all other potential functions (including the separator sets) are updated to be consistent with the new evidence.

To compute the marginal probability for multiple attribute-value pairs, sequential operations can be performed to (a) extract the marginal probability for each single attribute/value pair, and then (b) insert this pair as evidence into the set of potential functions. For example, if the probability p(A=1, B=1) is to be determined, first p(A=1) is extracted, and then the junction tree is updated to reflect the observation that A=1. As a result, the tree represents the conditional probability of all other attributes, given the observation that A=1. Thus, after this update, the probability p(B=1|A=1) can be extracted using the procedure just described, and by taking the product of these two, the probability of interest can be obtained.

Sparse Bayesian networks are often, but not always, compiled into undirected clique graphs with relatively small cliques. Various traditional learning algorithms can be applied to generate a Bayesian network that can be compiled into a undirected clique graph with a specific maximum clique size.

Learning Bayesian Networks from Data

One approach to learning Bayesian networks from data involves taking an observed set of data, and determining the structure and parameters of the network that fits that data well. As with other machine-learning problems, there can be a tradeoff between representing the training data well and the expected generalization error of the model.

In order to learn a Bayesian network for which inference is fast, one technique is to search among structures that are decomposable. A decomposable structure is one that is consistent with a clique graph in the sense that the number of parameters in the clique graph is the same as the number of parameters in the Bayesian network. In this case, transforming the Bayesian network in to the clique graph does not involve introduction of new parameters. An example technique for learning a decomposable model involves inserting edges to a Bayesian network using “undirected” operators. To do so, a Bayesian network having no edges is obtained. Then edges can be added greedily using the “undirected addition” operators. Using “undirected addition” operators in this manner guarantees that after each such operator, the resulting network is decomposable. Most standard scoring functions are appropriate for this search. Details regarding example undirected operators that are suitable for use with various inventory management techniques described herein can be found in “Optimal Structure Identification with Greedy Search” by David Maxwell Chickering, Journal of Machine Learning Research, 3:507-554 (2002), which is incorporated by reference herein in its entirety.

### Availability Computation Using Bayesian Networks

As noted, advertisers 120 may want to know whether a prospective order can be satisfied, or more generally, how many impressions X are available given some targeting criteria tⱼ. Inventory management techniques described herein can be employed to obtain quick answers to such availability queries from advertisers 120.

In order to answer availability queries, the inventory-management system and/or inventory manager 116 can be configured to model how the existing orders are going to be delivered. Under one example of order delivery, designated as a “priority winner” model, each order is assigned a unique priority. As each impression comes into the system, it is assigned to an order with the highest priority. Orders are removed from the system once their impression goals are met.

Before describing availability computations in detail, it is useful to consider the problem of deciding whether a given set of booked orders can be delivered. Assuming the priority winner delivery model, the following algorithm can be used to accomplish this task:

Algorithm CheckOrders

```
  Input: set of orders Oₗ, ..., Oₘ
  Output: FAIL if under-delivery occurs, or SUCCEED if successful
(1) Sort the orders by priority
(2) For each order Oᵢ = {Nᵢ, tᵢ} in turn
    a. Let N be the total number of impressions that match order i's
      targeting criteria tᵢ
    b. For each order Oⱼ for j=1 to i-1, subtract from N the fraction
      of booked impressions Nⱼ in order j that overlap with order i
    c. If N is less than the number of booked impressions Nᵢ for
      order i, return FAIL
(3) Return SUCCEED
```

Bayesian networks can be used to compute N from step 2a above. In particular, the value of N can be computed as: N=M×p(tᵢ), where M is the total volume expected and where the probability is computed using inference on a Bayesian network constructed from historic data.

As a heuristic, the Bayesian network can also be employed to compute the overlap between orders as designated in step 2b above. In particular, the overlap can be computed as: Overlap=Nⱼ×p(tᵢ|tⱼ), where the probability is computed using inference in the same Bayesian network as was learned from historic data. Overlap represents the fraction of the impressions will be delivered to the jth order that will match the targeting criteria for order i. In summary, the algorithm checks each order as follows: (1) find out the total number of impressions that match the order, and (2) subtract off those impressions that will be given to orders of higher priority.

As mentioned, using the “baseline” original distribution of attributes represented by a Bayesian network to compute the overlap computation is a heuristic. Conceptually, the algorithm CheckOrders can be used to compute availability for a prospective new order. This computation starts with the set of order items already booked, which by induction will not under-deliver. Then, a search is made for the maximum number of impressions that can be booked without under-delivery by repeatedly calling CheckOrders with the prospective order included. Each iteration can use a specific number of requested impressions for the prospective order. For example, initially one impression can be designated for the prospective order. As long as the call to CheckOrders succeeds, this number can be increased by one and CheckOrders can be run again. This process can be employed to return a maximum number of impressions for which the call to CheckOrders succeeded.

In at least some embodiments, an optimization can be implemented to solve the above maximization problem more efficiently. In particular, let X denote the number of impressions that can be allocated to a new prospective order. The optimization can be configured to maximize X, subject to the condition that Algorithm CheckOrders will SUCCEED if X impressions are booked for the order. Recall that Nⱼ is the number of impressions booked for order Oⱼ. Assume now that the indices reflect priority order once the new order has been added, and that the new order has priority i. Thus, Nᵢ₊₁ denotes the number of impressions booked by the order that comes next in priority order from the new one. Further, recall that tⱼ is the set of tags targeted by order Oⱼ.

There are two types of constraints imposed by X for the algorithm CheckOrders. First, after subtracting the higher-priority order intersections in step 2b, a number of remaining impressions that result is sufficient to serve X impressions for the new order. In other words, the algorithm does not return FAIL. This first constraint can be expressed as follows:

$$X \leq M \times p ( {t}_{i} ) - {\sum }_{j < i} {N}_{j} \times p ( {t}_{i} \vert {t}_{j} )$$

Note that N=M×p(tᵢ) is equal to N in step 2a, and the sum is implementing the subtraction done in step 2b.

Second, after serving X impressions to the prospective order, a number of remaining impressions that results is sufficient to serve the booked, lower-priority orders. This second constraint can be expressed as follows:

$${∀}_{k > i} {N}_{k} \leq M \times p ( {t}_{k} ) - X \times p ( {t}_{k} \vert {t}_{i} ) - [ {\sum }_{j \neq i , j < k} {N}_{j} \times p ( {t}_{k} \vert {t}_{j} ) ]$$

Here, the “for all” is restricting the orders considered in step 2 to be those with lower priority than the new order. Here, the subtraction made in step 2b is broken into two terms: the intersection with the new order (e.g., index i) and the intersection of all higher-priority orders not equal to the new order. Note that under-delivery of orders with higher priority than the new prospective order is not a concern because it is assumed initially that the existing set of orders will not under-deliver.

Re-arranging the terms in the second class of constraint result in the following expression:

$${∀}_{k > i} X \leq \frac{M \times p ( {t}_{k} ) - {N}_{k} - [ {\sum }_{j \neq i , j < k} {N}_{j} \times p ( {t}_{k} \vert {t}_{j} ) ]}{p ( {t}_{k} \vert {t}_{i} )}$$

In this re-arrangement, notice that the availability question is of the form “maximize X”, where each of the constraints is a constant upper bound for X. Thus, a number of impressions available to a new prospective order can be obtained by finding the minimum upper bound from above.

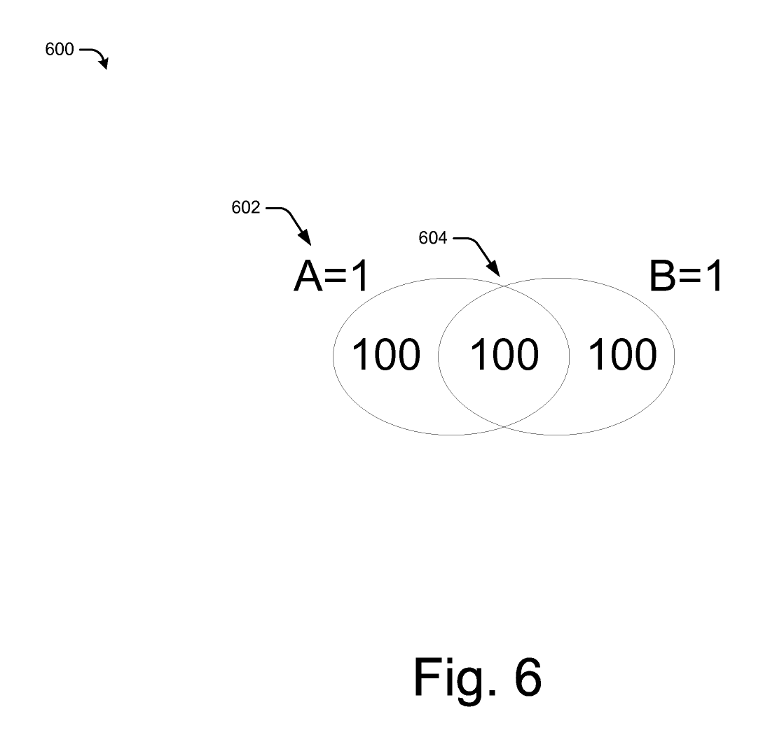

As was mentioned above, using the “baseline” Bayesian network to compute the overlap fractions p(tᵢ|tⱼ) is a heuristic. To understand why this computation may be insufficient, consider FIG. 6 which depicts generally at 600 an example population represented as a Venn diagram 602. In the example of FIG. 6, there are 200 impressions with A=1 and 200 impressions with B=1. These impressions have an overlap 604 that is depicted as 100 impressions having both A=1 and B−1. Now, suppose there are two existing orders as follows:

O₁={100,{A=1,B=1}}

O₂={100,{B=1}}

Further, assume that the priority of the first order is higher than the priority of the second order, and that a query is input to determine how many impressions are available for a prospective order with lowest priority that is targeting A=1. The described approach starts with the total number of impressions for which A=1, which is 200. Then, for each order, the overlap with A=1 is subtracted off, using the baseline distribution. Now assume that this baseline distribution represents the fractions exactly from the Venn diagram depicted in FIG. 6. In this example, first 100 impressions are subtracted off from the first order, because each impression targeted by O1 has A=1. This results in N=100 after the first subtraction. For the second order, and additional number of impressions equal to 100×p(A=1|B=1) is subtracted off. Notice from the counts in the Venn diagram that p(A=1|B=1)=100/200=0.5. Thus, an additional 50 impressions are subtracted from N, resulting in an availability of 50 for the new order.

Looking at this example carefully, notice that the subtraction for the second order may be inaccurate. In particular, the subtraction was computed as p(A=1|B=1) from the original distribution, whereas the correct distribution is the one that results after subtracting the impressions from the first order. In particular, after subtracting all 100 [A=1,B=1] impressions, p(A=1|B=1) is zero. Thus, the correct availability for the new order is 100. Accordingly, using the original distribution instead of the post-subtraction distribution can result in inaccuracies such as both overestimating and underestimating the available inventory.

In contrast, the inventory management techniques described above and below enable the expected post-subtraction distribution of attributes to be represented using a probabilistic model such as a Bayesian network. By so doing, the inventory management techniques avoid inaccuracies that can occur when availability computations are performed using just the original distribution. In particular:
(1) The overlap computation is no longer a heuristic, and the inventory that is available after orders have been booked can be represented more accurately.
(2) The speed of availability computations can be increased by caching the post-subtraction distributions.

By way of example, assume a Bayesian network B that represents the distribution of inventory that will be available to some order Oi. For the highest-priority order, this network can be the original Bayesian network representing the distribution of attributes over the users. Using inventory management techniques described above and below, B can be modified to represent the expected distribution that results after the impressions from Oi have been subtracted. This expected distribution corresponds to the distribution that will be available the next time a prospective order is considered.

To compute the expected post-subtraction distribution, assume that the impressions from the distribution are generated in a random order. As a result, the subtraction produces an expected distribution based on the random ordering of the impressions. For example, if an order targets 100 males, and half of males are sports fans according to the probabilistic model, it can be expected that the order will consume 50 sports fans. Because the males are coming in randomly, though, the number of sports fans actually consumed can deviate from this expected value.

Using concentration results, a bound can be placed on how far away the expectation is likely to be from the actual distribution. In particular, bounds can be accumulated in the form: with a probability at least 0.9999, the number of impressions available to this order is at least 80% of the expectation computed from the model.

In order to answer inference queries, assume again the Bayesian network is compiled into a junction tree. Thus, explicit modifications to the junction tree representation of a Bayesian network can be considered as opposed to modifications to the network itself. Of course, computations could also be applied to compute availability directly using a Bayesian network or other probabilistic model. It just so happens that for this example, the Bayesian network is compiled into a junction tree.

Now, assume that the targeted attributes tᵢ are contained within at least one clique node Cⱼ in the junction tree. Then, the following update to the potential function ψⱼ will reflect the (expected) post-subtraction potential function. For each set of values c in the domain of the potential function, adjust using:

$${ψ}_{j}^{′} ( {C}_{j} = c ) = {ψ}_{j} ( {C}_{j} = c ) \frac{p ( {C}_{j} = c ) \times M - I ( {t}_{i} ∼ c ) \times {N}_{i}}{p ( {C}_{j} = c ) \times ( M - {N}_{i} )}$$

In the preceding expression, I(tᵢ˜c) is the indicator function that is 1 if the targeted values tᵢ are consistent with the set of values c (that is, tᵢ does not “disagree” with c on any overlapping attribute values) and 0 otherwise. M denotes the number of impressions remaining in the population over which B is defined.

As a further example, consider the potential function introduced above, which is repeated here:

| A | B | Ψ(A, B) | p(A, B) |
|---|---|---|---|
| 0 | 0 | 12 | 0.33 |
| 0 | 1 | 10 | 0.28 |
| 1 | 0 | 6 | 0.17 |
| 1 | 1 | 8 | 0.22 |

Note that the above table includes a column containing the probability of each set of values. These probabilities are simply the normalized potential function values. For example, the probability p(A=0, B=0) results from dividing 12 by 36 (=12+10+6+8).

Assume M=100, and a subtraction of 10 impressions results from an order targeting A=1. A corresponding update can be made as follows:

$$ψ ( A = 0 , B = 0 ) = 12 \frac{0.33 \times 100 - 0 \times 10}{0.33 \times ( 100 - 10 )} = 13.3$$

$$ψ ( A = 0 , B = 1 ) = 10 \frac{0.28 \times 100 - 0 \times 10}{0.28 \times ( 100 - 10 )} = 11.1$$

$$ψ ( A = 1 , B = 0 ) = 6 \frac{0.17 \times 100 - 1 \times 10}{0.17 \times ( 100 - 10 )} = 2.7$$

$$ψ ( A = 1 , B = 1 ) = 8 \frac{0.22 \times 100 - 1 \times 10}{0.22 \times ( 100 - 10 )} = 4.8$$

A corresponding updated table of the potential values can be obtained as follows:

| A | B | ψ(A, B) | p(A, B) |
|---|---|---|---|
| 0 | 0 | 13.3 | 0.42 |
| 0 | 1 | 11.1 | 0.34 |
| 1 | 0 | 2.7 | 0.08 |
| 1 | 1 | 4.8 | 0.15 |

Note that after subtracting the A=1 impressions, the probability for seeing subsequent A=1 impressions has decreased as expected. After updating the clique as described, the information can be propagated throughout the rest of the junction tree, as can be done with any other evidence.

If an order targets attributes that are not contained within a single clique, one option is to sample a data set of size M randomly from the current distribution, explicitly subtract Ni impressions that match the given targets, and then re-learn a Bayesian network on the resulting data. Another option would be to add the evidence to multiple cliques, ignoring the dependences that were created.

Having described example implementation details regarding inventory management, consider now an example system that can be employed to implement aspects of the described techniques.

Example System

FIG. 7 illustrates generally at 700 an example computing device 702 that may implement the various embodiments described above. The computing device 702 may be, for example, a client 124 of FIG. 1, a server of a service provider 102, a server of an advertiser 120, or any other suitable computing device.

The computing device 702 includes one or more processors or processing units 704, one or more memory and/or storage components 706, one or more input/output (I/O) interfaces 708 for input/output (I/O) devices, and a bus 710 that allows the various components and devices to communicate one to another. The bus 710 represents one or more of several types of bus structures, including a memory bus or memory controller, a peripheral bus, an accelerated graphics port, and a processor or local bus using any of a variety of bus architectures. The bus 710 can include wired and/or wireless buses.

The memory/storage component 706 represents one or more computer storage media. The memory/storage component 706 may include volatile media (such as random access memory (RAM)) and/or nonvolatile media (such as read only memory (ROM), Flash memory, optical disks, magnetic disks, and so forth). The memory/storage component 706 may include fixed media (e.g., RAM, ROM, a fixed hard drive, etc.) as well as removable media (e.g., a Flash memory drive, a removable hard drive, an optical disk, and so forth).

The one or more input/output interfaces 708 allow a user to enter commands and information to computing device 700, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may comprise “computer-readable storage media.”

Software or program modules, including the inventory manager 116, applications 108, service manager module 112, operating system 110, and other program modules, may be embodied as one or more instructions stored on computer-readable storage media. The computing device 702 may be configured to implement particular functions corresponding to the software or program modules stored on computer-readable storage media. Such instructions may be executable by one or more articles of manufacture (for example, one or more computing device 702, and/or processors 704) to implement techniques for inventory management, as well as other techniques. Such techniques include, but are not limited to, the example procedures described herein. Thus, computer-readable storage media may be configured to store instructions that, when executed by one or more devices described herein, cause various techniques for inventory management.

The computer-readable storage media includes volatile and non-volatile, removable and non-removable media implemented in a method or technology suitable for storage of information such as computer readable instructions, data structures, program modules, or other data. The computer-readable storage media can include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or another tangible media or article of manufacture suitable to store the desired information and which may be accessed by a computer.

### CONCLUSION

Although the techniques for inventory management have been described in language specific to structural features and/or methodological steps, it is to be understood that the techniques defined in the appended claims are not necessarily limited to the specific features or steps described. Rather, the specific features and steps are disclosed as example forms of implementing the claimed techniques.

1. A computer-implemented method comprising:
collecting data for a traffic model that describes historic interaction of clients with a service provider;
constructing a probabilistic model that represents an inventory of ad impressions available from the service provider based on the traffic model;
booking one or more orders from advertisers for the ad impressions;
updating the probabilistic model to reflect an expected probabilistic decrease in the inventory of ad impressions due to the one or more orders that are booked; and
utilizing the updated probabilistic model to determine whether the inventory of ad impressions is sufficient to book a subsequent order for ad impressions.

2. The computer-implemented method of claim 1, wherein:
the ad impressions in the inventory are defined by values for a plurality of attributes; and
the probabilistic model is constructed to represent a distribution of the attributes and relate the attributes one to another based on dependencies between the attributes.

3. The computer-implemented method of claim 1, wherein the probabilistic model comprises a Bayesian network that represents relationships between attributes associated with the ad impressions.

4. The computer-implemented method of claim 1, wherein the probabilistic model comprises an undirected graphical representation of relationships between attributes associated with the ad impressions.

5. The computer-implemented method of claim 1, wherein constructing the probabilistic model comprises:
learning a Bayesian network that represents a distribution of attributes that define the ad impressions available from the service provider using the traffic model; and
deriving from the Bayesian network an undirected graph that organizes groups of dependent attributes into cliques and has edges between adjoining cliques that store probability distributions for attributes that are common between the adjoining cliques.

6. The computer-implemented method of claim 1, wherein the inventory comprises ad impressions that are used by the service provider to deliver advertising space in webpages to one or more advertisers.

7. The computer-implemented method of claim 1, wherein the inventory relates to advertising emails that are communicated to clients.

8. The computer-implemented method of claim 1, wherein the inventory relates to advertising space used to display ads within a user interface of a desktop application.

9. The computer-implemented method of claim 1, wherein utilizing the updated probabilistic model to determine whether the inventory of ad impressions is sufficient to book the subsequent order comprises:
obtaining the subsequent order as a query configured to initiate a determination regarding how many ad impressions having one or more attributes targeted by the query are available in the inventory;
responsive to the query, calculating a number of available ad impressions having the one or more targeted attributes using the updated probabilistic model; and
selectively booking the subsequent order according to the number of available ad impressions that is calculated.

10. One or more computer-readable storage media storing instructions that, when executed by one or more server devices, cause the one or more server devices to implement an inventory manager configured to:
receive a prospective order from an advertiser for ad impressions;
obtain a probabilistic model of inventory for ad impressions available from a service provider that reflects orders that have been booked by the service provider;
calculate a number of ad impressions available to satisfy the prospective order using the probabilistic model; and
selectively book the prospective order based upon the calculated number of ad impressions that are available.

11. One or more computer-readable storage media of claim 10, wherein the instructions, when executed by the one or more server devices, further cause the one or more server devices to implement the inventory manager to:
update the probabilistic representation of inventory for the ad impressions to account for ad impressions consumed by the prospective order when the prospective order is booked; and
determine availability of ad impressions for another prospective order using the updated probabilistic representation.

12. One or more computer-readable storage media of claim 10, wherein the probabilistic model comprises a Bayesian network that represents relationships between attributes associated with the ad impressions.

13. One or more computer-readable storage media of claim 10, wherein the probabilistic model comprises an undirected graphical representation of relationships between attributes associated with the ad impressions that includes one or more groups of dependent attributes.

14. One or more computer-readable storage media of claim 10, wherein the inventory comprises ad impressions that are used by the service provider to deliver advertising space in webpages to one or more advertisers.

15. One or more computer-readable storage media of claim 10, wherein the inventory relates to advertising emails that are communicated to the clients.

16. One or more computer-readable storage media of claim 10, wherein obtaining the probabilistic model comprises constructing an undirected graph that groups dependent attributes into cliques and has edges between adjoining cliques that store probability distributions for attributes that are common between the adjoining cliques.

17. A computing system comprising:
one or more processors; and
computer readable storage media having one or more modules stored thereon, that, when executed via the one or more processors, cause the computing system to perform acts including:
receiving a prospective order from an advertiser for ad impressions;
obtaining a Bayesian network that probabilistically represents inventory for ad impressions available from a service provider based upon one or more orders that have been booked by the service provider;
calculating a number of ad impressions available to satisfy the prospective order using the Bayesian network;
booking the prospective order based upon the calculated number of ad impressions that are available;
updating the Bayesian network of inventory for ad impressions to account for ad impressions consumed by the prospective order that is booked; and
determining availability of ad impressions for another prospective order using the updated Bayesian network.

18. The computer system of claim 17, wherein the Bayesian network is configured to represent a distribution of attributes that define the ad impressions and relate the attributes one to another based on dependencies between the attributes.

19. The computer system of claim 17, wherein updating the Bayesian network of inventory for ad impressions to account for ad impressions consumed by the prospective order that is booked comprises computing an expected distribution of attributes of the ad impressions based on the order that is booked by at least subtracting out the ad impressions consumed by the order that is booked and obtaining the expected distribution of attributes according to the remaining inventory.

20. The computer system of claim 17, wherein the inventory comprises ad impressions related to interactions of clients to obtain resources provided via the service provider, the ad impressions used by the service provider to enable advertisers to place advertisements for presentation to the clients in conjunction with webpages served to the clients in response to the interactions.
